(19) United States
(12) Patent Application Publication
(10) Pub. No.: US 2003/0153336 A1
(43) Pub. Date: Aug. 14, 2003

(54) Device to remotely control recording of radio and internet audio broadcast programming

(76) Inventor: Steven D. Williams, Portland, OR (US)

Correspondence Address: Pillsbury Winthrop LLP, Intellectual Property Group, 1600 Tysons Boulevard, McLean, VA, 22102, US

(21) Appl. No.: 10/074,771

(22) Filed: Feb. 12, 2002

(51) Int. Cl. H04B 7/00

(52) U.S. Cl. 455/514; 455/412

(57) ABSTRACT

A system to record an input signal representing an audio signal. At least one tuner/sampler device receives and samples the input signal, the input signal being receivable via at least (a) the Internet and (b) a radio transmission. A reception controller device configures settings of the at least one tuner/sampler device. A recordation control device controls the recording of the input signal, and the recordation control device controls the reception controller device. A communication device receives recording instructions from a remote device and transmits the recording instructions to the at least one tuner/sampler device, and the communication device receives the recording instructions from at least the Internet.

### BACKGROUND OF THE INVENTION

1. Field of the Invention

The present invention generally relates to a recordation control device to control recording of audio broadcast programming. More specifically, the present invention relates to a system, method, and apparatus to remotely control recording of radio and Internet audio broadcast programming, via a receiver and a tuner coupled with at least one radio reception device on a local network.

2. Discussion of the Related Art

There are television programming recording systems in the art that allow a user to digitally record a television program. Such systems (e.g., TIVO) typically have a display screen from which the user can utilize a remote control to select a television program to digitally record. The user can select a program to record, and when the program is aired, the program signal is digitally sampled and recorded onto a storage device such as a hard disk drive. Such systems can be used to record television programs transmitted via cable or satellite. However, current systems are capable only of recording television programming and can record programs only from certain television sources (e.g., satellite, cable, and VHF or UHF broadcast signals), but not from the Internet. Also, the systems are typically programmable only when the user is in close physical proximity to the system (i.e., via the use of an infrared remote control).

There are sound recording application programs in the art. Such application programs can be used to sample and record Internet radio broadcasts. However, the application programs currently used typically only allow a user to record Internet broadcasts, not off-the-air broadcast radio programs (e.g., Amplitude Modulation (AM) or Frequency Modulation (FM) broadcasts, or other broadcasts transmitted via a shortwave radio frequency or satellite, etc.). Also, although some application programs allow the user to record Internet broadcasts from different sources (i.e., different websites with different Internet Protocol (IP) addresses), the user must typically determine and enter the recordation settings (e.g., sampling rate, sample size, and IP source address) locally through the use of a computer executing the recording program. Therefore, the user cannot record a different Internet broadcast when away from the computer running the program (i.e., remotely). For example, if the user has the program set to record a one hour Internet broadcast of disco music, the user cannot remotely change the settings to instead record a broadcast of a presidential address, for example, broadcast from a different Internet source.

Also, the current programs typically only begin recording programs after the user has preconfigured the program to record such radio broadcasts. Therefore, a problem arises when a user is listening to a song, for example, and decides after a minute or so to record that song. Systems in the current art are insufficient because they do not allow a user to record a portion of the song before the user hits a “record” button or initiates a record function to record and save the recordation.

Therefore, prior art systems are deficient. Typical recording programs do not record both off-the-air radio and Internet audio broadcasts; they must be programmed locally by the user, and they typically only begin recording programs after the user has initiated a recording routine to record such radio broadcasts.

### BRIEF DESCRIPTION OF THE DRAWINGS

FIG. 1 illustrates a general overview of a recordation control device connected to local electronic devices on a local area network according to an embodiment of the present invention;

FIG. 2 illustrates a remote computer accessing a local web server that directs packets to and from web pages on a local area network according to an embodiment of the present invention;

FIG. 3 illustrates a receiver electrically coupled to local tuner/sampler devices according to an embodiment of the present invention;

FIG. 4 illustrates an example of a display screen for a recording application program according to an embodiment of the present invention;

FIG. 5 illustrates a process utilized to determine and display available broadcast programming according to an embodiment of the present invention;

FIG. 6 illustrates a process to allow a user to select a broadcast program to sample and record according to an embodiment of the present invention;

FIG. 7 illustrates a process utilized to store a sampled broadcast program on a storage device according to an embodiment of the present invention;

FIG. 8 illustrates a process utilized to determine from which device on a local network to sample and record a selected audio program; and

FIG. 9 illustrates a process utilized to sample and record a portion of a broadcast program before the user has prompted the system to record the broadcast program according to an embodiment of the invention.

### DETAILED DESCRIPTION

An embodiment of the present invention is directed to a system, method and apparatus to allow a user to control the tuning and recording of audio broadcasts, such as those transmitted via the Internet or via radio transmissions. The embodiment may include a recordation control device to control a plurality of tuner/sampler devices capable of receiving and sampling the audio broadcasts. The tuner/sampler devices may function as radios, for example. Such tuner/sampler devices may be programmed by the recordation control device to record the audio broadcasts. The system may also determine which broadcast channels are available and the names of programs being broadcast, and display such information to a user of the system. The system allows the user to locally or remotely control the recording of the audio programming.

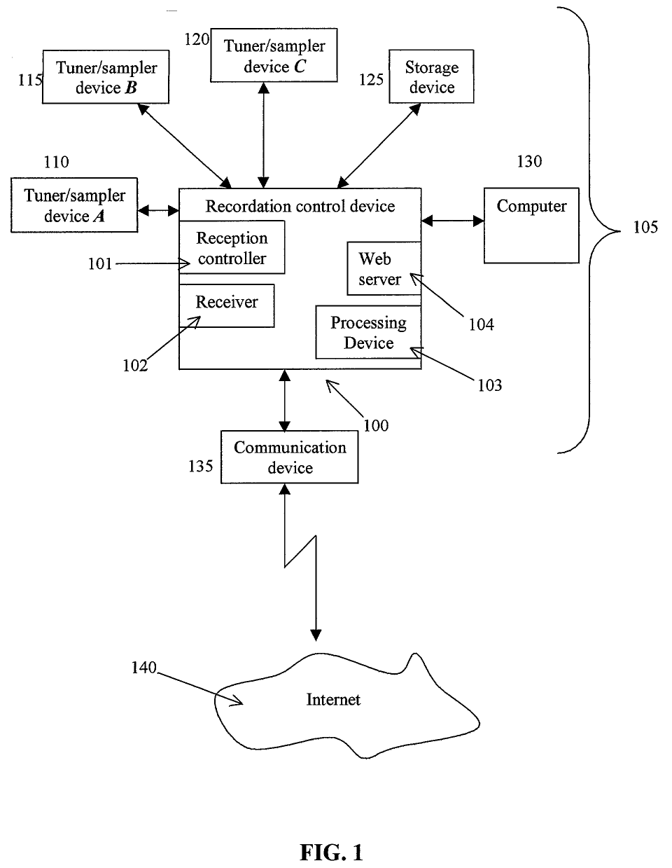

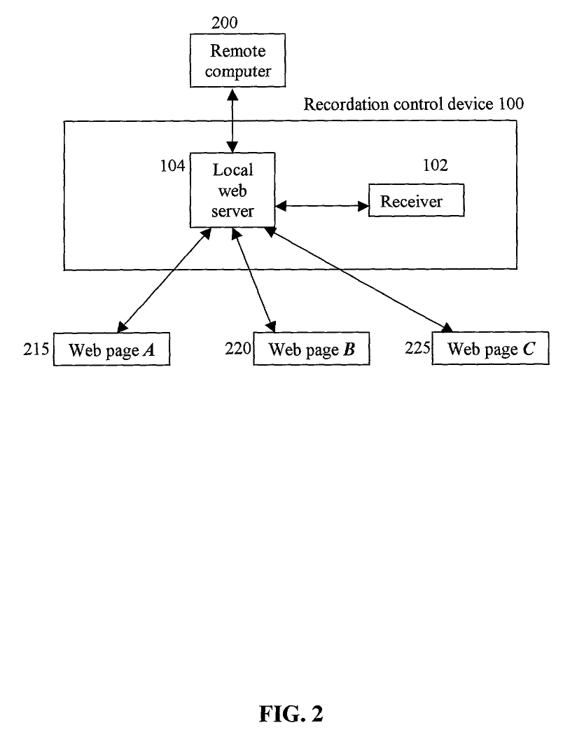

FIG. 1 illustrates a general overview of a recordation control device 100 connected to local electronic devices 110, 115, 120, 125, 130, and 135 on a local area network 105 according to an embodiment of the present invention. The recordation control device 100 may include a reception controller 101 to tune an audio reception device (e.g., tuner/sampler device A 110, B 115, or C 120) to which it is coupled. For example, if tuner/sampler device A 110 is capable of receiving FM radio signals, the reception controller 101 may be utilized to tune, or set, the frequency of a signal to be received by tuner/sampler device A 110. The tuner/sampler device A 110 may be set to receive a signal at 104.3 MHz, for example. The recordation control device 100 may also include a receiver 102 to communicate with electronic devices 110, 115, 120, 125, 130, and 135 on the local area network 105. The receiver 102 may receive signals from the electronic devices, such as a signal representing a sampled audio broadcast, for example. Although the disclosed embodiment of the recordation control device 100 has a reception controller 101 and a receiver 102 integrated into the same device, the reception controller 101 and/or the receiver 102 may be located in separate devices in other embodiments. The recordation control device 100 may also include a processing device 103 such as a Central Processing Unit (CPU). The processing device 103 may be utilized to control the operation of the reception controller 101, the receiver 102, and communication with the devices on the local area network 105. The recordation control device 100 may also include a local area web server 104 to access a web page for each of the tuner/sampler devices A 110, B 115, or C 120, as explained below with respect to FIG. 2.

The local area network 105 may include a plurality of data tuner/sampler devices to receive and sample program signals, such as tuner/sampler devices A 110, B 115, and C 120, as shown in FIG. 1. In other embodiments, a different number of data reception devices may be utilized. Each of the tuner/sampler devices 110, 115, and 120 has a function of receiving a broadcast data signal, such as an Amplitude Modulation (AM) radio signal, a Frequency Modulation (FM) radio signal, an Internet broadcast signal, a satellite radio signal, or any other form of receivable signal representing an audio signal, and sampling the signal. For example, tuner/sampler device A 110 may be capable of receiving AM signals, tuner/sampler device B 115 may be capable of receiving FM signals, and tuner/sampler device C 120 may be capable of receiving Internet broadcast signals. In other embodiments, some of the tuner/sampler devices may receive more than one type of signal (e.g., tuner/sampler A 110 may receive AM and airplane channel broadcast signals).

The local area network 105 may also include a storage device 125, such as a hard disk drive, or a Random Access Memory (RAM). The storage device 125 may be utilized to store broadcast signals received and sampled by one of the tuner/sampler devices, 110, 115, or 120. The processing device 103 of the recordation control device 100 may be utilized to control the operation of tuner/sampler device A 110, for example. In a situation where tuner/sampler device A 110 is capable of receiving and sampling AM radio signals, tuner/sampler device A 110 may include components or circuitry to receive the signal and a sampling device or circuitry to sample (i.e., digitize) the received AM radio signal. The format of the sampled signal may be Moving Pictures Experts Group (“MPEG”) Audio Layer 3 (“MP3”), International Standards Organization (ISO)/International Electrotechnical Commission (IEC) 1172-2:1993/Cor 2:1999, published in 1999, Real Audio, a WAV file (the native digital audio format in Microsoft Windows), or any other suitable file format. As the signal is sampled, the processing device 103 may receive the sampled signal from tuner/sampler device A 110 and send the sampled data to the storage device 125 where it may be stored.

In an embodiment of the invention, each of the tuner/sampler devices 110, 115, and 120 “publish” a web page. The web page for each of the tuner/sampler devices 110, 115, and 120 may display information such as the current settings for the tuner/sampler device 110, 115, or 120. For example, if tuner/sampler device A 110 is currently tuned to 1120 kHz in the AM frequency band, that information may be displayed on the web page for tuner/sampler device A. Other information, such as whether tuner/sampler device A 110 is currently recording a program, or is set to begin recording a program at a predetermined time, may also be displayed. The web page may also include information about the current sampling conditions (e.g., the sampling rate and the number of bits of information acquired during each sample).

The local area network 105 may also include a computer 130 capable of displaying the web pages for the tuner/sampler devices 110, 115, or 120. Once the web pages are displayed, a user at the computer 130 may control the recording of a broadcast program through one of the tuner/sampler devices 110, 115, or 120 via these web pages. For example, if the user wishes to record a radio program at 1050 kHz in the AM band, the user may view the web page for tuner/sampler device A 110, or for any of the other tuner/sampler devices 115 or 120, capable of receiving the 1050 kHz channel. The user can then set tuner/sampler device A 110 to record the program at the 1050 kHz channel, and may specify the time during which the program is to be recorded, as well as the sampling rate and the bits of data acquired at each sampling point.

The local area network 105 may also include a communication device 135, to send and receive data from the Internet 140. The communication device 135 may be or include a modem or an Ethernet card, or example. A tuner/sampler device 110, 115, or 120 capable of receiving Internet radio broadcasts may receive an Internet broadcast through the communication device 135. Also, a remote device on the Internet 140, for example, may access the recordation control device 100 via the communication device 135 to control the recording of a data broadcast with one of the tuner/sampler devices 110, 115, or 120.

In an alternate embodiment of the invention, a reception device may be utilized to record sounds in a room. The reception device may be utilized to secretly record conversations in a room for surveillance purposes. For example, if a user knows that a babysitter is babysitting his/her child between 7 PM and 9 PM, the user may utilize a reception/sampling device including a microphone, or a set of microphones, to receive and sample sounds from the room.

FIG. 2 illustrates a remote computer 200 accessing a local web server 104 that may direct packets to and from web pages for the tuner/sampler devices (e.g., tuner/sampler device A 110, B 115, and C 120) on the local area network 105 according to an embodiment of the present invention. The local web server 104 may be housed within the recordation control device 100, for example. Each of the local tuner/sampler devices (e.g., tuner/sampler device A 110, tuner/sampler device B 115, and tuner/sampler device C 120) may publish a web page to the recordation control device 100. To “publish” a web page means to make the web page available to other devices. As shown in FIG. 2, tuner/sampler device A 110 publishes web page A 215, tuner/sampler device B 115 publishes web page B 220, and tuner/sampler device C 120 publishes web page C 225. For example, if tuner/sampler device A 110 is capable of receiving only AM radio signals between 700 kHz and 1200 kHz, that information may be published on web page A 215. A local Internet Protocol (IP) address of tuner/sampler device A 1 10 may also be published on web page A 215. Also, if the available programming schedule for that band is known, such information may also be published on the web page. Tuner/sampler devices B 115 and C 120 may also publish their respective web pages.

When the remote computer 200, or any other compatible remote device accesses the local web server 104, it may have access to the web pages for each of the tuner/sampler devices 110, 115, and 120 on the local area network 105. For example, if a user at the remote computer 200 wishes to record a radio program at 1050 kHz, the user may access the local web server 104 at the recordation control device 100. The user at the remote computer 200 may access the web pages via a web browser. The user at the remote computer 200 may then access the web pages (e.g., web pages A 215, B 220, and C 225) for each of the tuner/sampler devices A 110, B 115, and C 120, through the use of the web browser. The user may utilize the web browser to change the settings of a tuner/sampler device.

The recordation control device 100 may publish a web page for the entire local area network 105, and make the web page available, for example, over the Internet 140. This way, a user may access the recordation control device 100 remotely. Once a remote user has accessed the recordation control device 100 for the local area network 105, the user may then access the web page (e.g., web pages A 215, B 220, and C 225) for a specific tuner/sampler device (e.g., tuner/samplers A 110, B 115, or C 120). The web page for one of the tuner/sampler devices may then be accessed by either entering a name of the local device (e.g., tuner/sampler device A 110 may be known symbolically as “AM radio”). The local web server 104, which may function as an Internet web server, matches up a local Internet Protocol (“IP”) address of the selected tuner/sampler device with the symbolic name of the tuner/sampler device and establishes a link between the web page for the tuner/sampler device and the remote user. Alternatively, the web page for a selected tuner/sampler device may be accessed by clicking on a link to the web page for that tuner/sampler device.

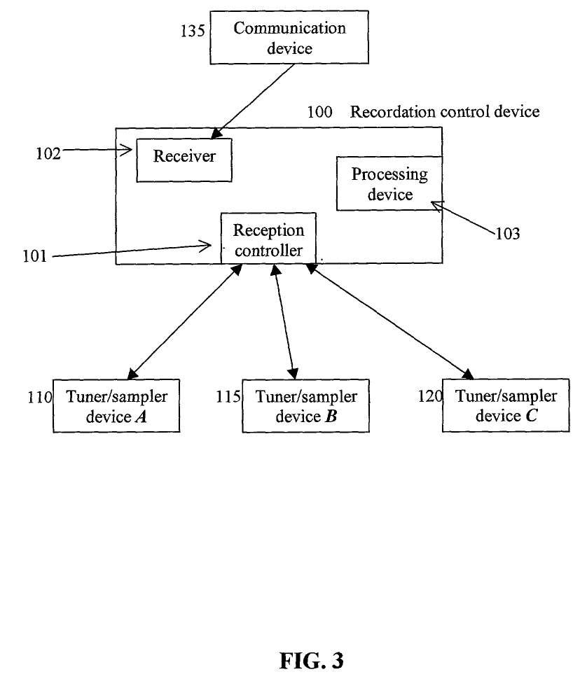

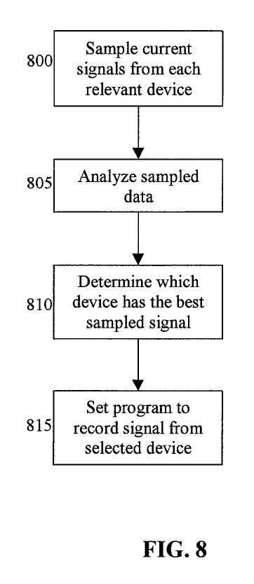

FIG. 3 illustrates the receiver 102 coupled to local tuner/sampler devices (e.g., A 110, B 115, or C 120) according to an embodiment of the present invention. The user at the remote computer 200 may control the recording of a broadcast program through the recordation control device 100. A remote or local user may contact the receiver 102 of the recordation control device 100 via the Internet 140. The user may send a control signal or a packet containing a selection, for example, to the communication device 135, which routes it to the receiver 102 of the recordation control device 100. The reception controller 101 can then tune the tuner/sampler device (e.g., A 1 10, B 115, or C 120) to record the selected program. If more than one of the tuner/samplers is capable of receiving the selected program, the system may prompt the user to select the device from which to record the program. Alternatively, the system may select the device that is receiving the strongest signal (e.g., in terms of amplitude or signal-to-noise ratio, for example), as further discussed below with respect to FIG. 8. In additional embodiments, the system may have predetermined priority knowledge. For example, if tuner/sampler device A 110 and tuner/sampler device B 115 are both capable of receiving the same radio program, the system may be preconfigured to record the radio program only on tuner/sampler device A 110. The system may be configured in such a way if it is known that tuner/sampler device A 110 is more reliable or has better recording circuitry or software, for example.

The user may also select the sampling rate and the amount of data taken per sample of a selected tuner/sampler device. For example, the user may select a sampling rate of 44 kHz, and may choose to sample at 128 kilo-bits/second (“kbps”). Although not illustrated, the local web server 104 may also reside within the recordation control device 100.

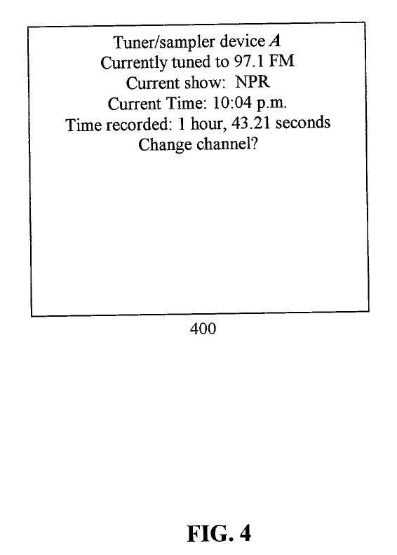

FIG. 4 illustrates an example of web page A 215 for tuner/sampler device A 110 according to an embodiment of the present invention. As illustrated, web page A 215 illustrates the name of the tuner/sampler device (e.g., “Tuner/sampler device A”). Web page A 215 may also list information such as (a) the frequency to which the tuner/sampler device is currently tuned, (b) the name or title of the current broadcast program being received on the tuned frequency, (c) the current local time, and (d) the length of time that a program has been recorded (if there is a program currently being recorded). Web page A 215 may also include a button or a prompt that is used to change the frequency or channel of the tuner. Web pages B 220 and C 225 may contain information similar to that in web page A 215. In other embodiments, additional information about the device or about a broadcast signal received may also be displayed.

When a user accesses the local network 105 either from a local device such as the local computer 130 or from a remote device such as the remote computer 200, the web pages (e.g., 215, 220, or 225) for tuner/sampler devices (e.g., 110, 115, or 120) on the local area network 105 are accessible to the user. The user may then, through the web pages for the tuner/sampler devices, configure a specific tuner/sampler device to sample a broadcast program at a particular time. The tuner/sampler devices may be configured to record AM, FM, or any other shortwave radio frequency, such as police band, etc., for example. Such a tuner/sampler device may then been tuned by the reception controller 101. Also, a tuner/sampler device may receive and record a broadcast program received via the Internet. For example, an Internet radio tuner/sampler device may also be tuned, but in a different way than a tuner/sampler device receiving a radio program signal via electromagnetic waves (i.e., radio waves). To tune the tuner/sampler device receiving the Internet radio, the source IP address of an Internet radio program may be changed to an IP address known to transmit a selected program.

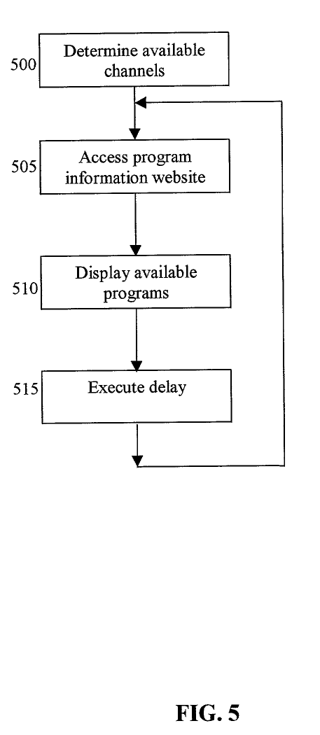

FIG. 5 illustrates a process utilized to determine and display available broadcast programming according to an embodiment of the present invention. First, the available broadcast channels are determined 500. For example, if it is known that the tuner/sampler device is capable of receiving radio signals on the AM band between 540 kHz and 1650 khz, then the recordation control device 100 may access 505 a programming schedule on the Internet via the communication device 135. The communication device 135 may then download the programming schedule and store it in its storage device 125. Programs for available channels may then be displayed 510 to the user. Finally, the process may execute a delay 515 for a predetermined time period and then re-access 505 the programming schedule website. The delay is utilized so that the process is not continually accessing the programming schedule via the Internet 140. The process may then repeat. The same process may occur for all of the tuner/sampler devices (e.g., A 110, B 115, or C 120) on the local network 105.

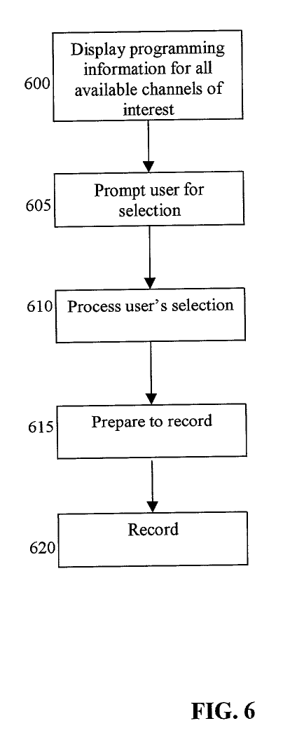

FIG. 6 illustrates a process to allow a user to select a broadcast program to sample and record according to an embodiment of the present invention. Each of the tuner/sampler devices (e.g., A 110, B 115, or C 120) publishes a web page (e.g., 215, 220, or 225, respectively). The recordation control device 100 may also publish its own web page that is linked to the web pages of each of the tuner/sampler devices. The process shown in FIG. 6 illustrates the processing that occurs when a user accesses the web page for a tuner/sampler device. First, programming information for all available channels of interest is displayed 600. The displayed channels may be all the channels capable of being received, or it may only include pre-selected channels. For example, there may be “40” available channels on the AM band. However, the user may only ever be interested in talk shows. Therefore, if “5” talk shows are available, only those “5” shows may be listed.

Next, the user is prompted 605 for a recording selection. For example, if only “Steve & Joe's Sportstalk” and “J. Persky's Political Insight” are available, the user may select “J. Persky's Political Insight” for recording. After the program has been selected, the system processes 610 the user's selection. The system then prepares 615 to sample and record the selected broadcast program. If the broadcast program is only receivable at a later time, then the system implements a timer routine to begin recording at the appropriate time. Finally, the system samples and records 620 the selected program at the desired time.

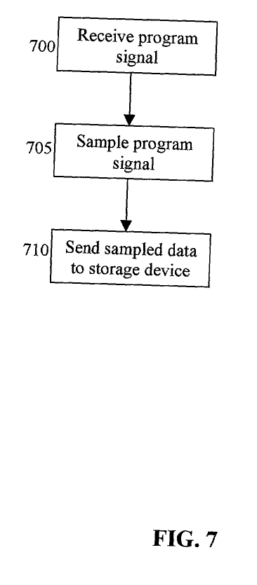

FIG. 7 illustrates a process utilized to store a sampled broadcast program on a storage device 125 according to an embodiment of the present invention. First, the tuner/sampler device receives 700 the program signal. The program signal may be a radio signal received by an antenna. Alternatively, it may be data packets received via the Internet from an Internet radio broadcasting location. In additional embodiments, the program signal may be contained in any other suitable form. The program signal is then sampled 705. As discussed above with respect to FIG. 4, the user may set the sampling rate. After the broadcast program signal is sampled, the sampled data is sent 710 to a storage device 125. The storage device 125 may be located at the tuner sampler device, on the local network 105, or on the Internet 140.

FIG. 8 illustrates a process utilized to determine from which device (e.g., A 10, B 115, or C 120) on a local network 105 to sample and record a selected audio program. There may be a situation where a radio program is simultaneously broadcast on the Internet and via an AM radio signal, for example. The system may determine which source is transmitting the best signal, and then record from that source. First, the system samples 800 current signals from each of the devices that receive the program signal. Next, the sampled data is analyzed 805. For example, noise characteristics, signal strength, etc. may be determined. The device that receives the best sampled signal is then determined 810. The system may then execute the routine illustrated in FIG. 7 to record 815 the program.

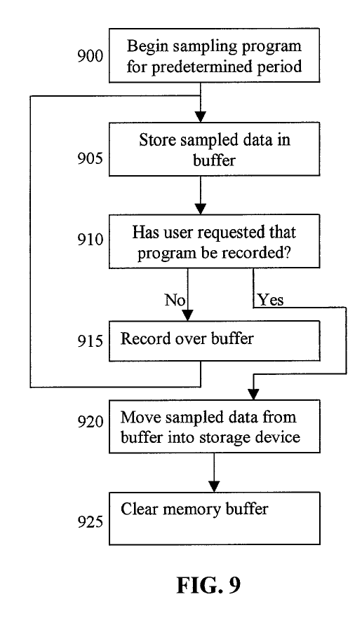

FIG. 9 illustrates a process utilized to sample and record a portion of a broadcast program before the user has prompted the system to record the broadcast program according to an embodiment of the invention. First, the processing begins sampling 900 the program for predetermined period. The predetermined period may be “3” minutes, for example. Therefore, the user may wait up to “3” minutes into a broadcast program before entering a “record” command and still record the entire program. Such an application is particularly useful if the user is tuned to an FM program playing pop music, for example. The user may listen to a song being broadcast and the user may record the entire song after hearing up to a full “3” minutes of the song. At step 905, the sampled data is stored in a memory buffer. The memory buffer may be a temporary storage device. After the program has been sampled and recording for the predetermined time period, the system determines whether the user has requested that the program be recorded 910. If the system determines 910 that the user has not, then the processing may begin to record 915 sampled data over data already stored in the memory buffer, and the processing returns to step 905. Such a process is similar to a “black box” recorder in an airplane, which stores only the most recent “30” minutes of flight data, continually recording over data older than “30” minutes. If the system determines 910 that the user has requested that the program be recorded 910, the sampled data in the memory buffer is moved 920 into the storage device 125. The memory buffer is then cleared 925, and the broadcast program is recorded in its entirety.

An embodiment of the present invention is directed to a system, method and apparatus to allow a user to control the tuning, sampling, and recording of audio broadcasts, such as those transmitted via the Internet or via a radio transmission. The embodiment may include a recordation control device to control tuner/sampler devices capable of receiving the audio broadcasts. The tuner/sampler devices may be programmed by the recordation control device to record the audio broadcasts. The system may also determine which broadcast channels are available and the names of programs being broadcast, and may display such information to a user of the system. The system may allow the user to locally or remotely control the recording of the audio broadcast.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A system to record an input signal representing an audio signal, comprising:
at least one tuner/sampler device to receive and sample the input signal, wherein the input signal is receivable via at least (a) an Internet and (b) a radio transmission;
a reception controller device to configure settings of the at least one tuner/sampler device;
a recordation control device to control the recording of the input signal, wherein the recordation control device controls the reception controller device; and
a communication device to receive recording instructions from a remote device and transmit the recording instructions to the at least one tuner/sampler device, wherein the communication device receives the recording instructions via at least an Internet.

2. The system of claim 1, wherein the input signal is at least one of: (a) a streaming signal broadcast via the Internet, (b) a transmitted radio signal, and (c) a signal output by a microphone.

3. The system of claim 1, wherein the recording instructions include settings for at least one of: (a) a sampling rate; (b) a sample size; (c) a source Internet Protocol (IP) address; (d) a source radio frequency channel; (e) a time to start recording; and (f) a file type.

4. The system of claim 3, wherein the file type is at least one of: (a) Moving Pictures Experts Group Audio Layer 3 (MP3) and (b) WAV file format.

5. The system of claim 1, further including a web server to publish a web page for the at least one tuner/sampler device.

6. The system of claim 1, wherein the reception controller device is housed within the recordation control device.

7. The system of claim 1, wherein the recordation control device implements a recording routine to constantly record a signal, and when prompted by a user, continue to record the signal and save to a file, along with signal data that was recorded up to a predetermined time before the user's prompt.

8. The system of claim 1, wherein the remote device is a computer executing a web browser program to send the recording instructions to the communication device.

9. The system of claim 1, wherein the recordation control device determines which of the at least one tuner/sampler device receives the best input signal to record.

10. The system of claim 1, wherein the recordation control device uses the communication device to contact a programming directory to determine available programs transmitted in the input signal to the at least one tuner/sampler device.

11. A method to record an input signal representing an audio signal, comprising:
configuring settings of at least one tuner/sampler device;
receiving the input signal, wherein the input signal is receivable via at least (a) an Internet and (b) a radio transmission;
sampling the input signal;
recording the input signal; and
receiving recording instructions from a remote device, wherein the recording instructions are at least receivable via the Internet.

12. The method of claim 11, wherein the input signal is at least one of: (a) a streaming signal broadcast via the Internet, (b) a transmitted radio signal, and (c) a signal output by a microphone.

13. The method of claim 11, wherein the recording instructions include settings for at least one of: (a) a sampling rate; (b) a sample size; (c) a source Internet Protocol (IP) address; (d) a source radio frequency channel; (e) a time to start recording; and (f) a file type.

14. The method of claim 13, wherein the file type is at least one of: (a) Moving Pictures Experts Group Audio Layer 3 (MP3) and (b) WAV file format.

15. The method of claim 11, further including publishing a web page for the at least one tuner/sampler device.

16. The method of claim 11, further including implementing a recording routine to constantly record a signal, and when prompted by a user, continuing to record the signal and save to a file, along with signal data that was recorded up to a predetermined time before the user's prompt.

17. The method of claim 11, wherein the remote device is a computer executing a web browser program to send the recording instructions to the communication device.

18. The method of claim 11, further including determining which of the at least one tuner/sampler device receives the best input signal to record.

19. The method of claim 11, further including contacting a programming directory to determine available programs transmitted in the input signal to the at least one tuner/sampler device.

20. A program code storage device, comprising:
a computer-readable medium; and
a computer-readable program code, stored on the computer-readable medium, having instructions to
configure settings of at least one tuner/sampler device,
receive the input signal, wherein the input signal is receivable via at least (a) an Internet and (b) a radio transmission,
sample the input signal,
record the input signal, and
receive recording instructions from a remote device, wherein the recording instructions are at least receivable via the Internet.

21. The program code storage device of claim 20, wherein the recording instructions include settings for at least one of: (a) a sampling rate; (b) a sample size; (c) a source Internet Protocol (IP) address; (d) a source radio frequency channel; (e) a time to start recording; and (f) a file type.

22. The program code storage device of claim 21, wherein the file type is at least one of: (a) Moving Pictures Experts Group Audio Layer 3 (MP3) and (b) WAV file format.

23. The program code storage device of claim 20, wherein the computer-readable program code further includes instructions to publish a web page for the at least one tuner/sampler device.

24. The program code storage device of claim 20, wherein the computer-readable program code further includes instructions to implement a recording routine to constantly record a signal, and when prompted by a user, continue to record the signal and save to a file, along with signal data that was recorded up to a predetermined time before the user's prompt.

25. The program code storage device of claim 20, wherein the remote device is a computer executing a web browser program to send recording instructions to the communication device.

26. The program code storage device of claim 20, wherein the computer-readable program code further includes instructions to determine which of the at least one tuner/sampler device receives the best input signal to record.

27. The program code storage device of claim 20, wherein the computer-readable program code further includes instructions to contact a programming directory to determine available programs transmitted in the input signal to the at least one tuner/sampler device.

28. An apparatus to control the recording of input signal representing an audio signal, comprising:
a reception controller to set an input signal source for at least one tuner/sampler device, wherein the input signal is receivable via at least (a) an Internet and (b) a radio transmission;
a receiver to receive recording instructions from at least one communication device, wherein the at least one communication device receives recording instructions from a remote device, and the recording instructions are at least receivable via the Internet; and
a processing device to control the reception controller.

29. The apparatus of claim 28, wherein the recording instructions include settings for at least one of: (a) a sampling rate; (b) a sample size; (c) a source Internet Protocol (IP) address; (d) a source radio frequency channel; (e) a time to start recording; and (f) a file type.

30. The apparatus of claim 29, wherein the file type is at least one of: (a) Moving Pictures Experts Group Audio Layer 3 (MP3) and (b) WAV file format.

31. The apparatus of claim 28, wherein the receiver publishes a web page for the at least one tuner/sampler device.

32. The apparatus of claim 28, wherein the receiver implements a recording routine to constantly record a signal, and when prompted by a user, continues to record the signal and saves to a file, along with signal data that was recorded up to a predetermined time before the user's prompt.

33. The apparatus of claim 28, wherein the remote device is a computer executing a web browser program to send recording instructions to the communication device.

34. The apparatus of claim 28, wherein the at least one recording device receiving the best input signal to record is determined.

35. The apparatus of claim 28, wherein the at least one communication device is used to contact a programming directory to determine available programs transmitted in the input signal to the at least one tuner/sampler device.
